(19) United States
(12) Patent Application Publication
(10) Pub. No.: US 2002/0130445 A1
(43) Pub. Date: Sep. 19, 2002

(54) Thermoplastic articles made from extrusion blow molded pre-forms

(75) Inventor: Erik Peterson, Grayslake, IL (US)

Correspondence Address: UNILEVER, PATENT DEPARTMENT, 45 RIVER ROAD, EDGEWATER, NJ, 07020, US

(73) Assignee: Unilever Home & Personal Care, USA

(21) Appl. No.: 09/811,909

(22) Filed: Mar. 19, 2001

(51) Int. Cl. B29C 49/00

(52) U.S. Cl. 264/530; 264/540

(57) ABSTRACT

A process for manufacturing a thermoplastic article which comprises the steps of:

a) extruding one or more thermoplastic resins, with a gas, through a screw and then a gate so as to form a partially soft parison;

b) and then positioning said parison within a cavity which has a shape which is complementary to the shape of the outer surface of said thermoplastic article;

c) and then blow molding said parison onto the cavity to form said thermoplastic article, and cooling said cavity so as to obtain any desired orientation of polymer molecules within one or more thermoplastic layers of the wall of said thermoplastic article.

### BACKGROUND OF THE INVENTION

Thermoplastic articles, such as bottles that are made using polyethylene terephthalate (PET) are currently made through the use of injection molded pre-forms. Such pre-forms are re-heated and then stretch blow molded into the final bottle shape. The stretching step allows for better orientation of the polymer. However, this process is expensive and time consuming and has other drawbacks that will be explained below. Moreover, the step of injection molding is not practical for use with less expensive resins like polypropylene when bottle design requires blow ratios greater than about 2:1 such as in narrow neck bottles.

It would be desirable to develop a method for preparing thermoplastic articles such as clear low cost bottles which is faster, less expensive, and suitable for use with less expensive polymers. It would also be desirable to provide a method for producing multi-layer articles.

These and other objects are achieved by the invention which is described below.

The following patents are related to the field of the invention.

U.S. Pat. No. 5,540,879 discloses a method of producing a blow-molded PET container suitable for hot-filling which includes the steps of injection molding a pre-form, blow-molding the pre-form into a primary molded article larger than the desired final container, heating the primary article in a series of oven chambers while its mouth is sealed so that pressure builds within the article to thereby control shrinkage, and blow-molding the shrunken article into the desired container. The two molds are preferably heated, and the mold contact time is as long as allowed by the manufacturing process to help remove internal stresses in the article. An apparatus for carrying out the method includes a first machine having an injection station, a thermal conditioning station, a primary blow-molding station, and an exit station. A second machine includes the oven chambers and a final blow-molding station. The primary article is sealed by a cap member that has a pressure relief valve connected to it to limit the internal pressure during heating, an air supply passage for final blow-molding, and a tensioning rod for insertion into the primary article and engaging a pocket in the center of the article's bottom. In some applications, it is necessary to stiffen the neck, particularly when hot-filling at about 200° F. or higher, or when using a closure roll-on die or a lugged neck finish to apply a bottle cap to the final container.

U.S. Reissue 029,065 discloses an improved method for forming blow molded articles of enhanced physical characteristics by orienting the material during the formation of the article. A two-stage blowing operation is provided wherein a pre-form blow mold effects a uniform and controllable transfer of heat from a freely extruded tube. The pre-form is conditioned, both thermally and dimensionally, within the pre-form for most effective orientation during a subsequent final blowing operation. Manipulatively, the disclosed method provides a completely overlapped pre-blowing and final blowing operation, and more than one set of pre-blow and final blow molds may be utilized at a single extruder orifice, if desired. Further, the direction and extent of movement of the molds adapts the method to presently existing blow molding machines, while increasing the machine output. Successively utilized blow tubes form and reform the open or blowing end of the tube to a final configuration. In the manufacture of containers, the two successively utilized blow tubes form an accurate, dimensionally stable finish for a bottle while also severing any neck flash from the finish.

### SUMMARY OF THE INVENTION

The invention relates to a process for manufacturing thermoplastic articles such as bottles from a thermoplastic resin which comprises:

1) manufacturing a pre-form using extrusion molding;

2) stretching and blow molding said pre-form in a secondary step so as to provide the orientation of the polymer, the clarity and the other desired physical properties of the bottle.

The invention also relates to thermoplastic articles made by the process of the invention, and pre-forms made by processes of the invention.

### DESCRIPTION OF THE FIGURES

FIG. 1 is a schematic, cross sectional view of a thermoplastic blow molding apparatus for blow molding pre-forms in the process of the present invention.

FIG. 2 is a cross sectional view of an apparatus used for stretch blow molding said pre-forms into a finally shaped thermoplastic article in the process of the invention.

### DETAILED DESCRIPTION OF THE INVENTION

As noted above, the process of the invention is for preparing thermoplastic articles such as bottles which:

(1) comprises manufacturing a pre-form using extrusion blow molding; and

(2) stretching and blow molding said pre-form in a secondary step so as to provide final shape to said article and to orientate said polymer in said thermoplastic resin so as to obtain said article.

The invention also relates to the thermoplastic articles so formed. The invention also relates to pre-forms made by the process of the invention.

As noted above, in the past processes, preparation of the pre-form has been carried out by injection molding, re-heating, and then stretch blow molding. Injection molding involves the use of a core and a cavity which are arranged so as to provide a volume in between. Thermoplastic resin is typically injected, under pressure, and in a molten state, through a gate and a screw and into the volume between the core and the cavity. The thermoplastic resin is allowed to cool and partially harden within the volume, thereby forming a pre-form.

The final article is then made by removing the pre-form from the core and the cavity (the core and the cavity, taken together, are called the mold), and stretch blow molding it into a larger cavity to form the final article.

There are a number of limitations to the injection molding process. First, the cost of tooling can be very expensive. Details, such as curves and indentations require the final cavity to be crafted into complementary shapes, with sizes and spacing that fall within very small tolerances, which is expensive to do.

Second, the injection molding process is usually limited to the preparation of monolayer articles. That is to say, the injection molding process is usually limited to the preparation of articles which have walls which are comprised of only one thermoplastic resin. This is because the arrangement whereby a resin is injected through a screw and a gate into a mold, allows only for one injection of one type of resin.

Third, the injection molding process for forming the pre-form usually takes a minimum of about 20 seconds from one injection to the next, thereby limiting the speed of production of thermoplastic articles.

Fourth, the injection molding process can only be used with certain expensive thermoplastic resins such as PET, and cannot be used with inexpensive resins like polypropylene. It is not practical for making narrow neck containers from these inexpensive resins because the blow ratios greater than about 2.5:1 are difficult to blow from these inexpensive resins.

In the process of the present invention, the pre-form is prepared by extrusion blow molding rather than by injection molding.

In extrusion blow molding, a thermoplastic resin is forced by heating and by back pressure from the material moving through the screw which forces the resin through the die which forms the parison. When said thermoplastic resin emerges from the end of said screw or tube, it forms a continous tube which is called a parison. The thermoplastic resin, at this instant, can have the consistency of a thick paste. The parison can then be allowed to cool to some extent and blow molded. That is, the parison is then positioned within a cavity which is complementary in shape to the outer surface of the final thermoplastic article, and a gas such as air is blown into the parison so as to cause it to mold to the inner surface of the cavity, thereby forming the shape of the pre-form. The cavity can then be cooled and the pre-form can be removed. The pre-form can then be inserted onto a blow pin, for example, and can then be made to undergo a stretch and blow molding process so as to form the thermoplastic article in its final shape.

This extrusion molding; and the stretch and blow molding process of the invention, has numerous advantages.

First, it allows for the formation of shapes of final articles that are of a greater variety than is possible through the use of injection blow molding, followed by blow molding. This is so, because any pre-form that is made by an injection molding step, cannot be removed from its mold for blow molding, if it has undercuts that exceed about 0.060″ in its shape.

Second extrusion molding; and the stretch and blow molding process of the invention, allows for the production of multi-wall thermoplastic articles. This is the case because multiple extruders (each has a screw) can by arranged so that each extrudes a different thermoplastic resin into the die that forms the parison. Multiple extruders can be arranged around the die, much as spokes are arranged around the hub of a wheel, with each extruder injecting a different thermoplastic resin into the die which forms the parison.

Each different thermoplastic resin can form a different layer in the wall of the resulting parison. Put another way, The thermoplastic resin forms a tube as it is forced through the die by the back pressure of the screw(s). The multiple extruders can be arranged so as to form a tube which has, for example, a wall which has an inner layer of one thermoplastic resin, and an outer layer of another thermoplastic resin.

During blow molding of this parison into its final shape within the cavity, a final article is formed which has a wall which has an inner layer of the one thermoplastic resin and an outer layer of the other thermoplastic resin. An advantage to having such a multi-walled final article is, for example, that you can produce, for example, a bottle which has a chemical resistant inner surface made of ethyl vinyl alcohol (EVOH), and has a high moisture barrier outer surface made of polyolefin such as polypropylene or polyethylene. This advantage forms another part of the present invention.

Another advantage of the extrusion molding, blow and stretch molding process of the present invention, is that it allows for the use of lower density thermoplastic resins than are typically used in an injection molding process.

Another advantage of the extrusion molding, blow and stretch molding process of the present invention is that in the final blow molding state, the conditions of manufacture can be arranged so that the strings of polymer molecules within the originally amorphous resin are aligned so as to produce a final clear plastic article. But it should be appreciated that processes of the present invention, and final articles of the present invention, are not limited to clear thermoplastic articles, but can also include, for example, translucent and opaque thermoplastic articles.

In the process of the present invention, the ratio of the size of the final thermoplastic article to the size of the pre-form can be about 1.5:1 to about 5.5:1 or greater, depending on the thermoplastic resin which is used. The ratio is called the blow ratio. For a given thermoplastic article the blow ratio of the length of the article to the pre-form can differ from the blow ratio of the width of the article to the width of the pre-form. For example, the blow ratio of the length can range from about 2:1 to about 4:1, or greater, or about 2.5:1 to about 4:1 or greater, depending on the resin used and the process has been carried out wherein this blow ratio of length is about 3:1 and between about 2:1. The blow ratio of width can range from about 1.5:1 to about 3.5:1 or greater depending on the resin used, and the process has been carried out wherein the width ratio is about 2.5:1 to about 2.1:1.

In the process of the invention, the thickness of the wall of the pre-form can range from about 0.060 inches to about 0.200 inches, more preferably about 0.10 inches to about 0.15 inches. An example of a process of the invention has been carried out wherein the thickness of the wall of the pre-form was about 0.125 inches and in another case the wall of the pre-form was about 0.130 inches. An advantage of the process of the present invention is that it allows for the fabrication of pre-form which are formed by injection molding. Therefore, the process of the present invention can be carried out by using less thermoplastic resin, for each article, and thus, the process of the present invention is more economical than the injection blow molding process for forming a pre-form.

The pre-form can be fabricated so as to have uniform wall thicknesses. By “uniform wall thicknesses” is meant thicknesses which are +0.05 inches to about 0.008 inches, more preferably about +0.010 inches. Uniform wall thicknesses for the pre-form allow the final thermoplastic article to have a uniform wall thickness. Alternatively, when it is desired to have a final thermoplastic article which has walls of differing thicknesses, then this can be accomplished by fabricating the pre-form so as to have walls of differing thickness.

The amount of time (cycle time) that elapses in the formation of a pre-form can range from about 5 to about 30 seconds, depending on the resin which is employed. An example of a process of the invention has been carried out wherein the cycle time was about 20 seconds and where the cycle time was about 30 seconds. When the resin employed was polypropylene, the extruder temperature was about 450 degrees F. Different resins will be extruded at different temperatures.

The fabrication of pre-forms using the process of the present invention is typically accomplished more quickly (that is, with a lower cycle time) than is the process of forming a pre-form by injection blow molding. Consequently, the process of the present invention is more economical than processes which employ an injection molding step to form the pre-form.

The process of the present invention also allows for the use of multiple cavities in the fabrication of the pre-form. This allows for the formation of pre-forms which have varied shapes. Such pre-forms can be blow molded into final thermoplastic articles of varied shapes.

Any thermoplastic resin which can be extrusion blow molded and then blow molded, can be employed in the process of the present invention. Non-limiting examples of such thermoplastic resins include polypropylene, polyethylene, polyamide, acrylnitrile, or polypropylene. Polypropylene resins which can be employed in the process of the invention include homopolymers and copolymers of polypropylene; and clarified and non-clarified polypropylene. As noted above, fusing the process of the present invention, there can be made multi-layered thermoplastic articles, wherein each layer is comprised of a different thermoplastic resin.

It will also be appreciated that techniques for handling a pre-form, after it has been fabricated, are known in the art. Such techniques include cooling, trimming, and reaming the pre-form. Techniques for handling the final thermoplastic article include cooling and trimming. The inclusion of such pre-form techniques and thermoplastic techniques does not take a process outside the scope of the present invention.

It will also be appreciated that depending on the selection of the cavity ether rounded or non-rounded final thermoplastic articles such as bottles may be fabricated.

Without intending to be bound by the following, it is pointed out that the process of the invention has been carried out to fabricate a closed ended tubular shaped pre-form which had a length of about 4.38 inches, a width of about 1.118 inches in diameter, a wall thickness of about 0.154 inches, a threaded neck (which was not re-heated and stretched in the second stage of the process, and a shoulder. This pre-form was then stretch blow molded in the process of the invention to form a final thermoplastic article which was a cylindrical bottle, with rounded shoulders, which had an opening of about 1.118 inches in diameter, a length of about 8.038 inches, a width of about 2.382 inches, and a uniform wall thickness(+0.010) inches.

Making reference to the figures of the specification, a detailed description of the manufacture of a clear, plastic article the invention is now provided.

Specific Processing on Pre-form and Bottle

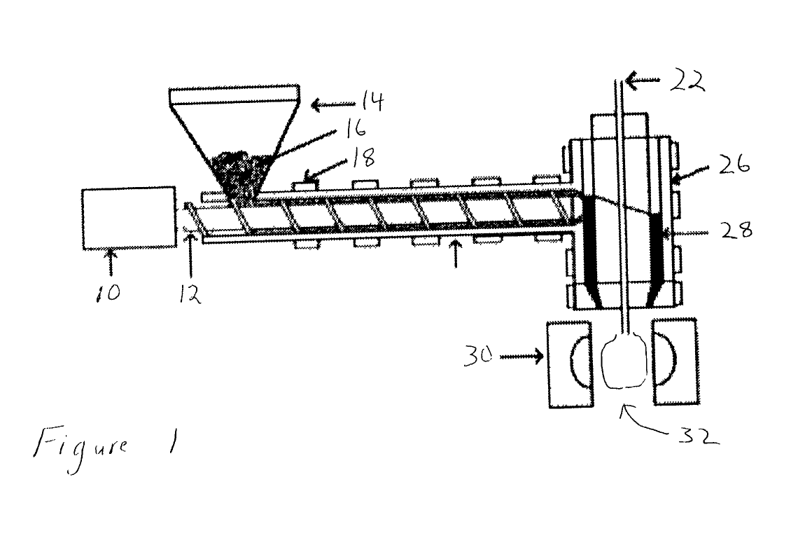

Referring to FIG. 1, it can be seen that screw motor, 10, rotates extruder screw, 12. As extruder screw, 12, rotates, raw plastic, 16, is fed from hopper, 14, into screw, 12. Rotation of screw 12, moves raw plastic, 16, toward accumulator die head, 26,. Heater bands, 18, are placed along the length of extruder barrel, 20, which in turn holds extruder screw, 12.

Heat from heat bands, 18, and from back pressure from the extrusion process, itself, transforms raw plastic, 16, into molten plastic. The molten plastic collects in accumulator die head, 26. A gas, such as air, is forced through blow pin , 22, to form parison, 28.

Parison, 28, is then blow molded by blow pin, 22. A gas, such as air, is forced though blow pin, 22, and the softened thermoplastic resin of parison, 28, is thereby made to conform to the inner walls of mold, 30, thus forming pre-form, 32, in its final shape.

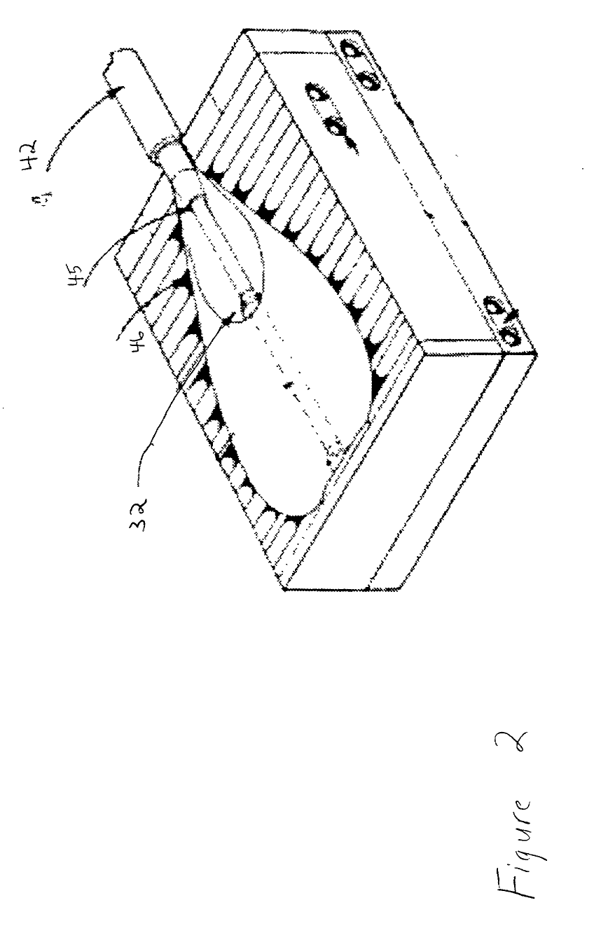

Pre-form, 32, may then be partially cooled, for example, by cooling gas. Pre-form, 32, may then be removed from blow pin, 22, and transported by a conveyor belt (not shown) or by other means which are known in the art, to the stretch-blow molding apparatus shown in FIG. 2, where it may be inserted upon stretch-blow pin, 42. A combination of pushing and blowing, the pre-form, 32, causes it to conform to the inner wall of mold, 45, so as to form the thermoplastic article, 46, in its final shape. The thermoplastic article may be cooled and then stripped from stretch blow pin, 42.

What is claimed is:

1. A process for manufacturing a thermoplastic article which comprises the steps:
a) Extrusion, blow molding one or more thermoplastic resins into a pre-form;
b) and stretch blow molding, said pre-form into a thermoplastic article.

2. A process according to claim 1, wherein blow ratio between thermoplastic resin and pre-form is about 1.5:1 or greater.

3. A process according to claim 1, wherein wall thickness of said pre-form is uniformly within about 0.010 inches.

4. A process according to claim 1, wherein multiple cavities are used in said extrusion, molding process.

5. A process according to claim 1, wherein wall thickness of said pre-form is about 0.06 inches to about 0.20 inches.

6. A process according to claim 1, wherein said pre-form is cooled prior to said stretch blow molding process.

7. A process according to claim 1, wherein said thermoplastic resin is one or more resins selected from the group consisting of polypropylene, polyethylene, polyamide, and acrylonitrile.

8. A process according to claim 7, wherein said polypropylene is selected from the group consisting of a homopolymer of polypropylene, a copolymer of polypropylene, a clarified polypropylene, and a non-clarified polypropylene.

9. A process according to claim 1, wherein said thermoplastic article is clear.

10. A process according to claim 1, wherein said thermoplastic article is translucent oropaque.

11. A process according to claim 1, wherein polymer molecules is said thermoplastic article are biaxially aligned.

12. A thermoplastic pre-form comprised of one or more thermoplastic resins wherein said thermoplastic pre-form is manufactured by a process comprising the step of extrusion blow molding.

13. A thermoplastic pre-form according to claim 12, wherein said thermoplastic resins are one or more resins selected from the group consisting of polypropylene, polyethylene, polyamide, and acrylonitrile.

14. A thermoplastic article made by the process of claim 1.

15. A process according to claim 1, wherein blow length ratio is about 2.5:1 to about 3.5:1.

16. A process according to claim 1, wherein blow width ratio is about 2:1 to about 3:1.
